(19) United States
(12) Patent Application Publication
(10) Pub. No.: US 2010/0214438 A1
(43) Pub. Date: Aug. 26, 2010

(54) IMAGING DEVICE AND IMAGE PROCESSING METHOD

(75) Inventors: Yusuke Hayashi, Tokyo (JP); Shigeyasu Murase, Tokyo (JP)

Correspondence Address: PROCOPIO, CORY, HARGREAVES & SAVITCH LLP, 525 B STREET, SUITE 2200, SAN DIEGO, CA, 92101, US

(73) Assignee: Kyocera Corporation, Kyoto (JP)

(21) Appl. No.: 11/996,931

(22) PCT Filed: Jul. 28, 2006
(86) PCT No.: PCT/JP2006/315047

§ 371 Date: Mar. 3, 2009

(30) Foreign Application Priority Data
Jul. 28, 2005 (JP) 2005-219405
Nov. 29, 2005 (JP) 2005-344309
Jul. 21, 2006 (JP) 2006-199813

(51) Int. Cl. H04N 5/235

(52) U.S. Cl. 348/229.1; 348/E05.037

(57) ABSTRACT

There are provided an imaging device and an image processing method capable of simplifying an optical system, reducing cost, and obtaining a restored image having a small noise affect. The imaging device includes an optical system (110) and an imaging element (120) for forming a primary image and an image processing device (140) for forming the primary image into a highly fine final image. In the image processing device (140), filter processing is formed for an optical transfer function (OTF) in accordance with exposure information from an exposure control device (190).

### CROSS-REFERENCE TO RELATED APPLICATION

This application is the United States national stage application of international application serial number PCT/JP2006/315047, filed 28 Jul. 2006, which claims priority to Japanese patent application no. 2005-219405, filed 28 Jul. 2005 and Japanese patent application no. 2005-344309, filed 29 Nov. 2005, each of which is incorporated herein by reference in its entirety.

### TECHNICAL FIELD

The present invention relates to an image pickup apparatus for use in a digital still camera, a mobile phone camera, a Personal Digital Assistant (PDA) camera, an image inspection apparatus, an industrial camera used for automatic control, etc., which includes an image pickup device and an optical system. The present invention also relates to an image processing method.

### BACKGROUND ART

Recently, as with the rapid development in digitalization of information, the digitalization in image processing is significantly required. As in digital cameras in particular, solid-state image pickup devices, such as Charge Coupled Devices (CCD) and Complementary Metal Oxide Semiconductor (CMOS) sensors, have been mainly provided on imaging planes instead of films.

In image pickup apparatuses including CCDs or CMOS sensors, an image of an object is optically taken by an optical system and is extracted by an image pickup device in the form of an electric signal. Such an apparatus is used in, for example, a digital still camera, a video camera, a digital video unit, a personal computer, a mobile phone, a PDA, an image inspection apparatus, an industrial camera used for automatic control, etc.

FIG. 1 is a schematic diagram illustrating the structure of a known image pickup apparatus and the state of ray bundles. Such an image pickup apparatus 1 includes an optical system 2 and an image pickup device 3, such as a CCD and a CMOS sensor. The optical system 2 includes object-side lenses 21 and 22, an aperture stop 23, and an imaging lens 24 arranged in that order from an object side (OBJS) toward the image pickup device 3. Referring to FIG. 1, in the image pickup apparatus 1, the best-focus plane coincides with the plane on which the image pickup device 3 is disposed. FIGS. 2A to 2C show spot images formed on a light-receiving surface of the image pickup device 3 included in the image pickup apparatus 1.

In addition, an image pickup apparatus, in which light is regularly dispersed by a phase plate and is reconstructed by digital processing to achieve a large depth of field, has been suggested (for example, see Non-patent Document 1-2 and Patent Document 1-5). Furthermore, an automatic exposure control system for a digital camera in which filtering process using a transfer function is performed has also been suggested (for example, see Patent Document 6).

Non-patent Document 1: “Wavefront Coding; jointly optimized optical and digital imaging systems,” Edward R. Dowski, Jr., Robert H. Cormack, Scott D. Sarama.

Non-patent Document 2: “Wavefront Coding; A modern method of achieving high performance and/or low cost imaging systems,” Edward R. Dowski, Jr., Gregory E. Johnson.

Patent Document 1: U.S. Pat. No. 6,021,005.

Patent Document 2: U.S. Pat. No. 6,642,504.

Patent Document 3: U.S. Pat. No. 6,525,302.

Patent Document 4: Patent Document 4: U.S. Pat. No. 6,069,738.

Patent Document 5: Japanese Unexamined Patent Application Publication No. 2003-235794.

Patent Document 6: Japanese Unexamined Patent Application Publication No. 2004-153497.

### DISCLOSURE OF THE INVENTION

### Problems to be Solved by the Invention

In the above-mentioned known image pickup apparatuses, it is premised that a Point Spread Function (PSF) obtained when the above-described phase plate is placed in an optical system is constant. If the PSF varies, it becomes difficult to obtain an image with a large depth of field by convolution using a kernel.

Therefore, setting single focus lens systems aside, in lens systems like zoom systems and autofocus (AF) systems, there is a large problem in adopting the above-mentioned structure because high precision is required in the optical design and costs are increased accordingly. More specifically, in known image pickup apparatuses, a suitable convolution operation cannot be performed and the optical system must be designed so as to eliminate aberrations, such as astigmatism, coma aberration, and zoom chromatic aberration that cause a displacement of a spot image at wide angle and telephoto positions. However, to eliminate the aberrations, the complexity of the optical design is increased and the number of design steps, costs, and the lens size are increased.

In addition, in the above-mentioned known image pickup apparatuses, for example, when an image obtained by shooting an object in a dark place is reconstructed by signal processing, noise is amplified at the same time. Therefore, in the optical system which uses both an optical unit and signal processing, that is, in which an optical wavefront modulation element, such as the above-described phase plate, is used and signal processing is performed, noise is unfortunately amplified and the reconstructed image is influenced when an object is shot in a dark place.

An object of the present invention is to provide an image pickup apparatus which is capable of simplifying an optical system, reducing the costs and obtaining a reconstruction image in which the influence of noise is small.

### Means for Solving the Problems

According to one aspect of the present invention, the image pickup apparatus includes an optical system, an image pickup device, a signal processor, a memory and an exposure control unit. The image pickup device picks up an object image that passes through the optical system. The signal processor performs a predetermined operation of an image signal from the image pickup device with reference to an operation coefficient. The memory for stores operation coefficient used by the signal processor. The exposure control unit controls an exposure. The signal processor performs a filtering process of the optical transfer function (OTF) on the basis of exposure information obtained from the exposure control unit.

The optical system preferably includes an optical wavefront modulation element and converting means for generating an image signal with a smaller dispersion than that of a signal of a dispersed object image output from the image pickup device.

The optical system preferably includes converting means for generating an image signal with a smaller dispersion than that of a signal of a dispersed object image output from the image pickup device.

The signal processor preferably includes noise-reduction filtering means.

The memory preferably stores an operation coefficient used by the signal processor for performing a noise reducing process in accordance with exposure information.

The memory preferably stores an operation coefficient used for performing an optical-transfer-function (OTF) reconstruction process in accordance with exposure information.

In the OTF reconstruction process frequency is preferably modulated by changing the gain magnification in accordance with the exposure information.

When the exposure is low, the gain magnification of high frequency is reduced.

The image pickup apparatus preferably includes a variable aperture.

Preferably, the image pickup apparatus further includes object-distance-information generating means for generating information corresponding to a distance to an object. The converting means generates the image signal with a smaller dispersion than that of a signal of the dispersed object on the basis of the information generated by the object-distance-information generating means.

Preferably, the image pickup apparatus further includes conversion-coefficient storing means and coefficient-selecting means. The conversion-coefficient storing means stores at least two conversion coefficients corresponding to dispersion caused by at least the optical wavefront modulation element or the optical system in association with the distance to the object. The coefficient-selecting means selects a conversion coefficient that corresponds to the distance to the object from the conversion coefficients in the conversion-coefficient storing means on the basis of the information generated by the object-distance-information generating means. The converting means generates the image signal on the basis of the conversion coefficient selected by the coefficient-selecting means.

Preferably, the pickup apparatus further includes conversion-coefficient calculating means for calculating a conversion coefficient on the basis of the information generated by the object-distance-information generating means. The converting means generates the image signal on the basis of the conversion coefficient obtained by the conversion-coefficient calculating means.

In the image pickup apparatus, the optical system preferably includes a zoom optical system, correction-value storing means, second conversion-coefficient storing means and correction-value selecting means. The correction-value storing means stores one or more correction values in association with a zoom position or an amount of zoom of the zoom optical system. The second conversion-coefficient storing means stores a conversion coefficient corresponding to dispersion caused by at least the optical wavefront modulation element or the optical system. The correction-value selecting means selects a correction value that corresponds to the distance to the object from the correction values in the correction-value storing means on the basis of the information generated by the object-distance-information generating means. The converting means generates the image signal on the basis of the conversion coefficient obtained by the second conversion-coefficient storing means and the correction value selected by the correction-value selecting means.

Each of the correction values stored in the correction-value storing means, preferably includes a kernel size of the dispersed object image.

Preferably, the image pickup apparatus further includes object-distance-information generating means and conversion-coefficient calculating means. The object-distance-information generating means generates information corresponding to a distance to an object. The conversion-coefficient calculating means calculates a conversion coefficient on the basis of the information generated by the object-distance-information generating means. The converting means generates the image signal with a smaller dispersion than that of a signal of the dispersed object on the basis of the conversion coefficient obtained by the conversion-coefficient calculating mean.

In the image pickup apparatus, the conversion-coefficient calculating means preferably uses a kernel size of the dispersed object image as a parameter.

Preferably, the image pickup apparatus further includes storage means. The conversion-coefficient calculating means stores the obtained conversion coefficient in the storage means. The converting means generates the image signal with a smaller dispersion than that of a signal of the dispersed object by converting the image signal on the basis of the conversion coefficient stored in the storage means.

The converting means preferably performs a convolution operation on the basis of the conversion coefficient.

Preferably, the image pickup apparatus further includes shooting mode setting means which sets a shooting mode of an object. The converting means performs a converting operation corresponding to the shooting mode which is determined by the shooting mode setting means.

Preferably, in the image pickup apparatus, the shooting mode is selectable from a normal shooting mode and one of a macro shooting mode and a distant-view shooting mode. If the macro shooting mode is selectable, the converting means selectively performs a normal converting operation for the normal shooting mode or a macro converting operation in accordance with the selected shooting mode. The macro converting operation reduces dispersion in a close-up range compared to that in the normal converting operation. If the distant-view shooting mode is selectable, the converting means selectively performs the normal converting operation for the normal shooting mode or a distant-view converting operation in accordance with the selected shooting mode. The distant-view converting operation reduces dispersion in a distant range compared to that in the normal converting operation.

Preferably, the image pickup apparatus further comprises conversion-coefficient storing means for storing different conversion coefficients in accordance with each shooting mode set by the shooting mode setting means and conversion-coefficient extracting means for extracting one of the conversion coefficients from the conversion-coefficient storing means in accordance with the shooting mode set by the shooting mode setting means. The converting means converts the image signal using the conversion coefficient obtained by the conversion-coefficient extracting means.

The conversion-coefficient calculating means preferably uses a kernel size of the dispersed object image as a conversion parameter.

In the image pickup apparatus, the shooting mode setting means includes an operation switch for inputting a shooting mode and object-distance-information generating means for generating information corresponding to a distance to the object in accordance with input information of the operation switch. The converting means performs the converting operation for generating the image signal with the smaller dispersion than that of the signal of the dispersed object image on the basis of the information generated by the object-distance-information generating means.

According to another aspect of the present invention, an image processing method includes a storing step, a shooting step and an operation step. In the storing step, the operation coefficient is stored. In the shooting step, an object image that passes through the optical system is picked up by the image pickup device. In the operation step, an operation, with reference to an operation coefficient of the image signal, obtained by the image pickup device is performed. In the operation step, a filtering process of the optical transfer function (OTF) on the basis of exposure information is performed.

### ADVANTAGES

According to the present invention, an optical system can be simplified, the costs can be reduced, and a reconstruction image in which the influence of noise is small can be obtained.

### BRIEF DESCRIPTION OF THE DRAWINGS

FIG. 1 is a schematic diagram illustrating the structure of a known image pickup apparatus and the state of ray bundles.

FIG. 2A to 2C illustrate spot images formed on a light-receiving surface of an image pickup device in the image pickup apparatus shown in FIG. 1 when a focal point is displaced by 0.2 mm (Defocus=0.2 mm), when the focal point is not displaced (Best focus) or when the focal point is displaced by −0.2 mm (Defocus=−0.2 mm), individually.

FIG. 3 is a block diagram illustrating the structure of an image pickup apparatus according to an embodiment of the present invention.

FIG. 4 is a schematic diagram illustrating the structure of an zoom optical system at a wide-angle position in an image pickup apparatus according to the embodiment;

FIG. 5 is a schematic diagram illustrating the structure of the zoom optical system at a telephoto position in the image pickup apparatus having the zoom function according to the embodiment;

FIG. 6 is a diagram illustrating the shapes of spot images formed at the image height center at the wide-angle position;

FIG. 7 is a diagram illustrating the shapes of spot images formed at the image height center at the telephoto position;

FIG. 8 is a diagram illustrating the principle of a wavefront-aberration-control optical system;

FIG. 9 is a diagram illustrating an example of data stored in a kernel data ROM (optical magnification);

FIG. 10 is a diagram illustrating another example of data stored in a kernel data ROM (F number);

FIG. 11 is a flowchart of an optical-system setting process performed by an exposure controller;

FIG. 12 illustrates a first example of the structure including a signal processor and a kernel data storage ROM;

FIG. 13 illustrates a second example of the structure including a signal processor and a kernel data storage ROM;

FIG. 14 illustrates a third example of the structure including a signal processor and a kernel data storage ROM;

FIG. 15 illustrates a fourth example of the structure including a signal processor and a kernel data storage ROM;

FIG. 16 illustrates an example of the structure of the image processing device in which object distance information and exposure information are used in combination;

FIG. 17 illustrates an example of the structure of the image processing device in which zoom information and the exposure information are used in combination;

FIG. 18 illustrates an example of a filter structure applied when the exposure information, the object distance information, and the zoom information are used in combination;

FIG. 19 is a diagram illustrating the structure of an image processing device in which shooting-mode information and exposure information are used in combination.

FIG. 20A to 20C illustrate spot images formed on a light-receiving surface of an image pickup device according to the embodiment when a focal point is displaced by 0.2 mm (Defocus=0.2 mm), when the focal point is not displaced (Best focus) or when the focal point is displaced by −0.2 mm (Defocus=−0.2 mm), individually;

FIG. 21A is a diagram for explaining an MTF of a first image formed by the image pickup device and illustrates a spot image formed on the light-receiving surface of the image pickup device included in the image pickup apparatus, while FIG. 21B is a diagram for explaining the MTF of the first image formed by the image pickup device and illustrates the MTF characteristic with respect to spatial frequency;

FIG. 22 is a diagram for explaining an MTF correction process performed by an image processing device according to the embodiment;

FIG. 23 is another diagram for explaining the MTF correction process performed by the image processing device;

FIG. 24 is a diagram illustrating the MTF response obtained when an object is in focus and when the object is out of focus in the known optical system;

FIG. 25 is a diagram illustrating the MTF response obtained when an object is in focus and when the object is out of focus in the optical system including an optical wavefront modulation element according to the embodiment;

FIG. 26 is a diagram illustrating the MTF response obtained after data reconstruction in the image pickup apparatus according to the embodiment;

FIG. 27 is a diagram illustrating an amount of lifting of the MTF (gain magnification) in inverse reconstruction.

FIG. 28 is a diagram illustrating an amount of lifting of the MTF (gain magnification) that is reduced in a high-frequency range.

FIGS. 29A to 29D show the results of simulation in which the amount of lifting of the MTF is reduced in the high-frequency range.

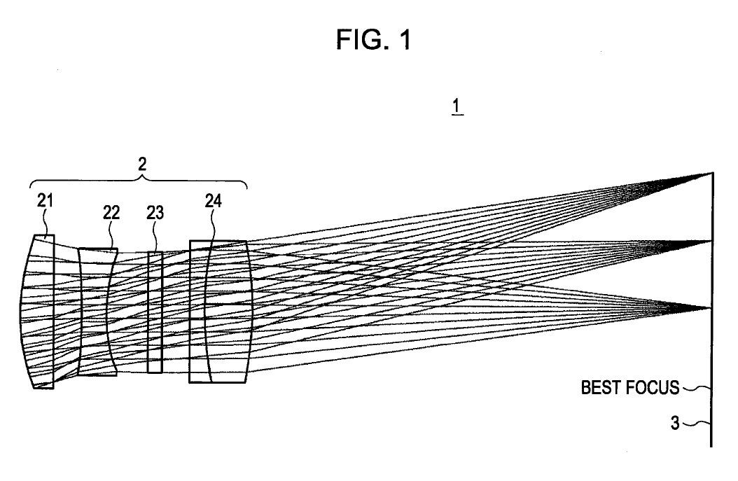

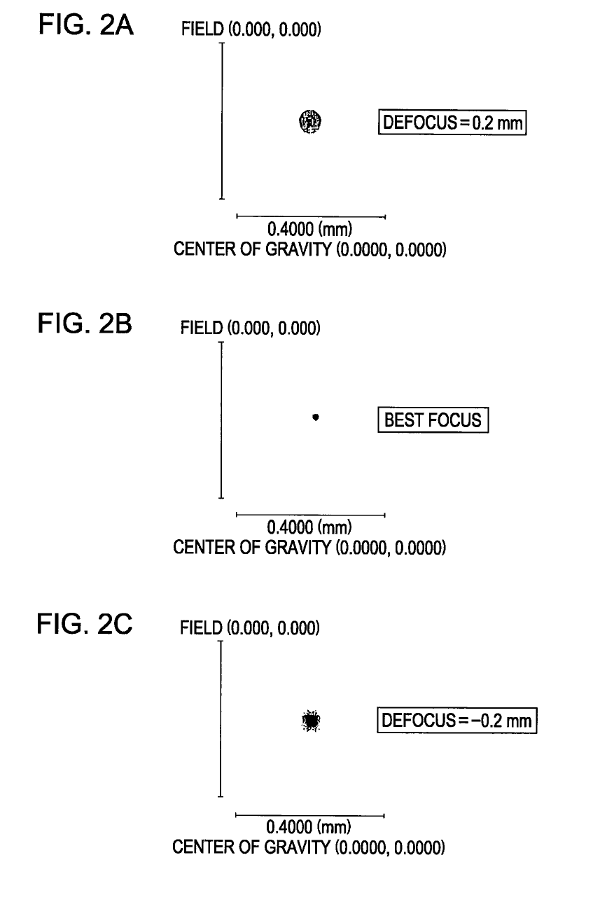

### REFERENCE NUMERALS

100: image pickup apparatus.
110: optical system.
120: image pickup device.
130: analog front end unit (AFE).
140: image processing device.
150: signal processor.
180: operating unit.
190: exposure controller.
111: object-side lens.
112: imaging lens.
113: wavefront coding optical element.
113a: phase plate (optical wavefront modulation element).
142: convolution operator.
143: kernel data storage ROM.
144: convolution controller.

### BEST MODE FOR CARRYING OUT THE INVENTION

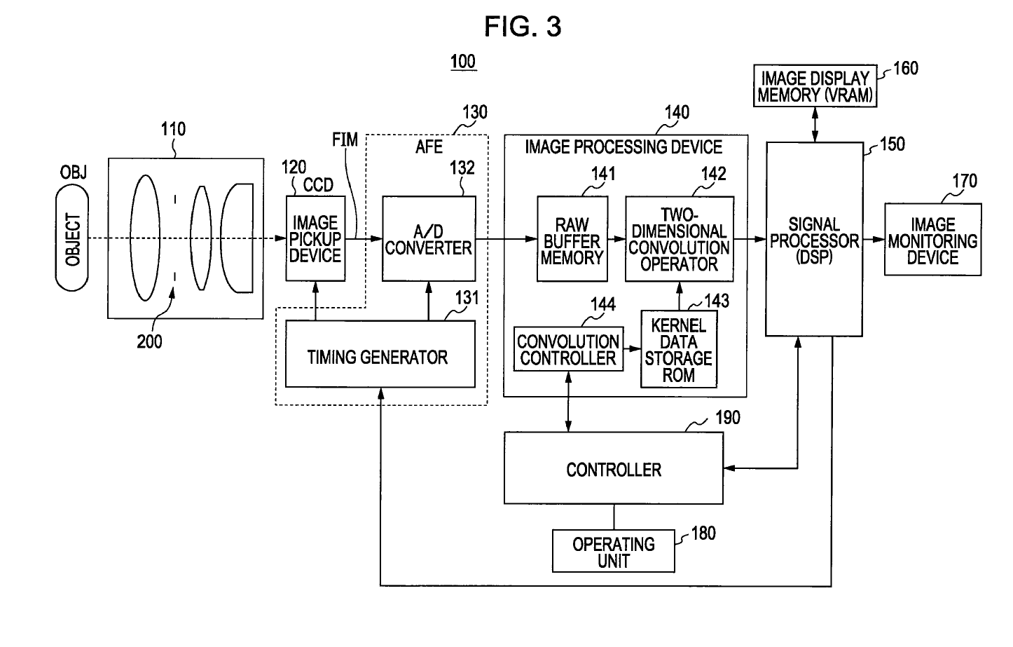

An embodiment of the present invention will be described below with reference to the accompanying drawings. FIG. 3 is a block diagram illustrating the structure of an image pickup apparatus according to an embodiment of the present invention.

An image pickup apparatus 100 according to the present embodiment includes an optical system 110, an image pickup device 120, an analog front end (AFE) unit 130, an image processing device 140, a signal processor (DSP) 150, an image display memory 160, an image monitoring device 170, an operating unit 180, and a controller 190.

The element-including optical system 110 supplies an image obtained by shooting an object OBJ to the image pickup device 120.

The image pickup device 120 includes a CCD or a CMOS sensor on which the image received from the element-including optical system 110 is formed and which outputs first image information representing the image formed thereon to the image processing device 140 via the AFE unit 130 as a first image (FIM) electric signal. In FIG. 3, a CCD is shown as an example of the image pickup device 120.

The AFE unit 130 includes a timing generator 131 and an analog/digital (A/D) converter 132. The timing generator 131 generates timing for driving the CCD in the image pickup device 120. The A/D converter 132 converts an analog signal input from the CCD into a digital signal, and outputs the thus-obtained digital signal to the image processing device 140.

The image processing device (two-dimensional convolution means) 140 functions as a part of the signal processor 150. The image processing device 140 receives the digital signal representing the picked-up image from the AFE unit 130, subjects the signal to a two-dimensional convolution process, and outputs the result to the signal processor 150. The signal processor 150 performs a filtering process of the optical transfer function (OTF) on the basis of the information obtained from the image processing device 140 and exposure information obtained from the controller 190. The exposure information includes aperture information. The image processing device 140 has a function of generating an image signal with a smaller dispersion than that of a dispersed object-image signal that is obtained from the image pickup device 120. In addition, the signal processor 150 has a function of performing noise-reduction filtering in the first step. Processes performed by the image processing device 140 will be described in detail below.

The signal processor (DSP) 150 performs processes including color interpolation, white balancing, YCbCr conversion, compression, filing, etc., stores data in the memory 160, and displays images on the image monitoring device 170.

The exposure controller 190 performs exposure control, receives operation inputs from the operating unit 180 and the like, and determines the overall operation of the system on the basis of the received operation inputs. Thus, the controller 190 controls the AFE unit 130, the image processing device 140, the signal processor 150, the variable aperture 110a, etc., so as to perform arbitration control of the overall system.

The structures and functions of the optical system 110 and the image processing device 140 according to the present embodiment will be described below.

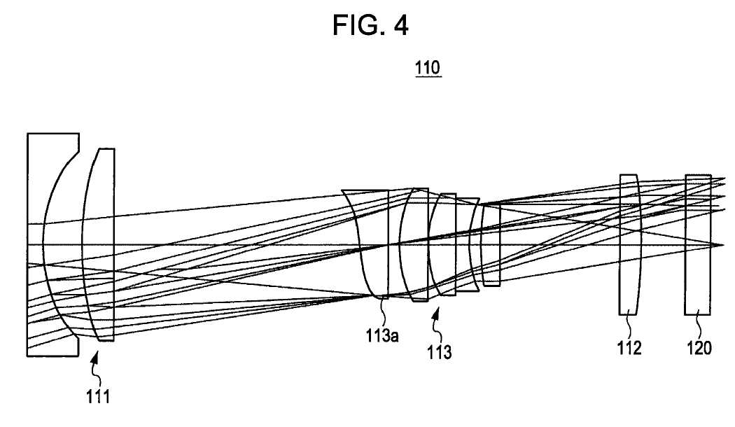

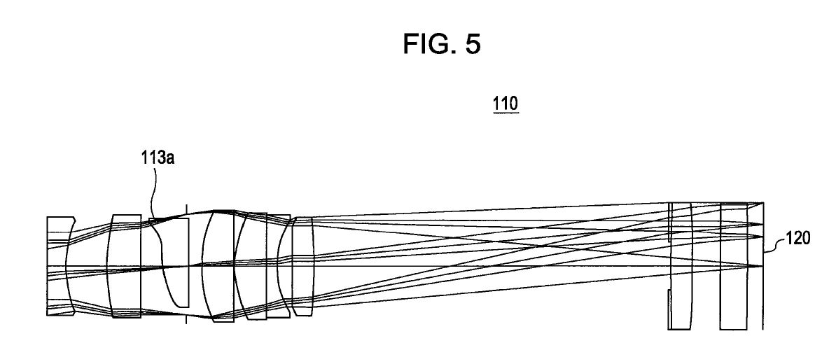

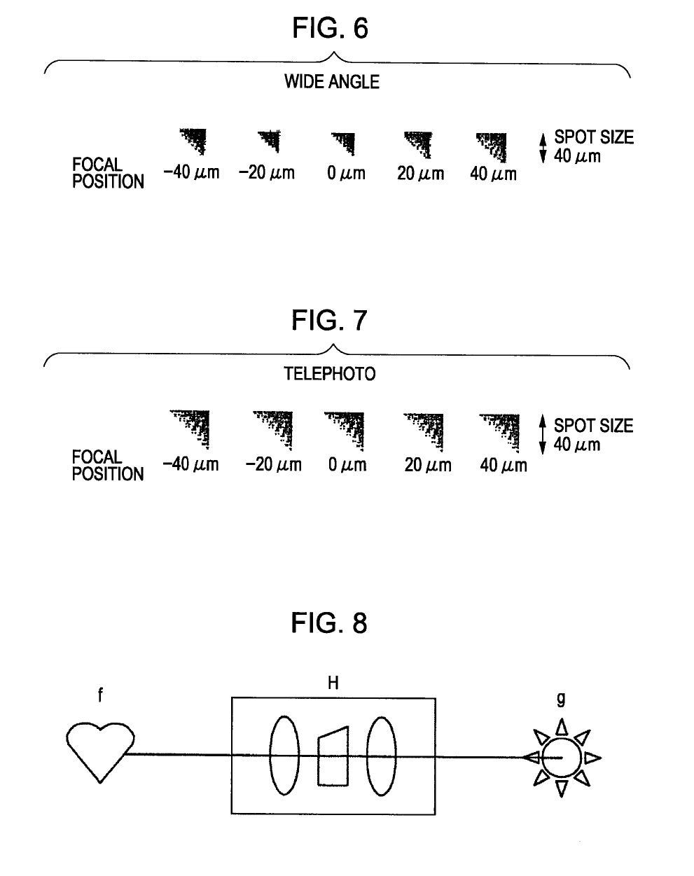

FIG. 4 is a schematic diagram illustrating a zoom optical system 110 according to the present embodiment. This diagram shows a wide-angle position. In addition, FIG. 5 is a schematic diagram illustrating the structure of the zoom optical system at a telephoto position according to the present embodiment. Furthermore, FIG. 6 is a diagram illustrating the shapes of spot images formed at the image height center at the wide-angle position and FIG. 7 is a diagram illustrating the shapes of spot images formed at the image height center at the telephoto position.

Referring to FIGS. 4 and 5, the zoom optical system 110 includes an object-side lens 111 disposed at the object side (OBJS), an imaging lens 112 provided for forming an image on the image pickup device 120, and a movable lens group 113 placed between the object-side lens 111 and the imaging lens 112.

The movable lens group 113 includes an optical wavefront modulation element (wavefront coding optical element) 113a for changing the wavefront shape of light that passes through the imaging lens 112 to form an image on a light-receiving surface of the image pickup device 120. The optical wavefront modulation element 113a is, for example, a phase plate having a three-dimensional curved surface. An aperture stop (not shown) is also placed between the object-side lens 111 and the imaging lens 112. In present embodiment, for example, the variable aperture 200 is provided and the aperture size (opening) thereof is controlled by the exposure control (device).

Although a phase plate is used as the optical wavefront modulation element in the present embodiment, any type of optical wavefront modulation element may be used as long as the wavefront shape can be changed. For example, an optical element having a varying thickness (e.g., a phase plate having an above-described three-dimensional curved surface), an optical element having a varying refractive index (e.g., a gradient index wavefront modulation lens), an optical element having a coated lens surface or the like so as to have varying thickness and refractive index (e.g., a wavefront modulation hybrid lens), a liquid crystal device capable of modulating the phase distribution of light (e.g., a liquid-crystal spatial phase modulation device), etc., may be used as the optical wavefront modulation element.

According to the present embodiment, a regularly dispersed image is obtained using a phase plate as the optical wavefront modulation element. However, lenses included in normal optical systems that can form a regularly dispersed image similar to that obtained by the optical wavefront modulation element may also be used. In such a case, the optical wavefront modulation element can be omitted from the optical system. In this case, instead of dealing with dispersion caused by the phase plate as described below, dispersion caused by the optical system will be dealt with.

The zoom optical system 110 shown in FIGS. 4 and 5 is obtained by placing the optical phase plate 113a in a 3× zoom system of a digital camera.

The phase plate 113a shown in FIGS. 4 and 5 is an optical lens that regularly disperses light converged by an optical system. Due to the phase plate, an image that is not in focus at any point thereof can be formed on the image pickup device 120.

In other words, the phase plate 113a forms light with a large depth (which plays a major role in image formation) and flares (blurred portions).

A system for performing digital processing of the regularly dispersed image so as to reconstruct a focused image is called a wavefront-aberration-control optical system. The function of this system is provided by the image processing device 140.

The basic principle of the wavefront-aberration-control optical system will be described below. As shown in FIG. 6, when an object image f is supplied to a optical system in the wavefront-aberration-control optical system H, an image g is generated.

This process can be expressed by the following equation:

g=H*f

where ‘*’ shows convolution.

In order to obtain the object from the generated image, the following process is necessary:

f=H−1*g

A kernel size and an operation coefficient of the H function will be described below. ZPn, ZPn−1, . . . indicate zoom positions and Hn, Hn−1, . . . indicate the respective H functions. Since the corresponding spot images differ from each other, the H functions can be expressed as follows:

$$Hn = ( \begin{matrix}a & b & c \\ d & e & f\end{matrix} )$$

$$Hn - 1 = ( \begin{matrix}{a}^{′} & {b}^{′} & {c}^{′} \\ {d}^{′} & {e}^{′} & {f}^{′} \\ {g}^{′} & {h}^{′} & {i}^{′}\end{matrix} )$$

The difference in the number of rows and/or columns in the above matrices is called the kernel size, and each of the numbers in the matrices is called the operation coefficient.

Each of the H functions may be stored in a memory. Alternatively, the PSF may be set as a function of object distance and be calculated on the basis of the object distance, so that the H function can be obtained by calculation. In such a case, a filter optimum for an arbitrary object distance can be obtained. Alternatively, the H function itself may be set as a function of object distance, and be directly determined from the object distance.

In the present embodiment, as shown in FIG. 3, the image taken by the optical system 110 is picked up by the image pickup device 120, and is input to the image processing device 140. The image processing device 140 acquires a conversion coefficient that corresponds to the optical system and generates an image signal with a smaller dispersion than that of the dispersed-image signal from the image pickup device 120 using the acquired conversion coefficient.

In the present embodiment, as described above, the term “dispersion” refers to the phenomenon in which an image that is not in focus at any point thereof is formed on the image pickup device 120 due to the phase plate 113a placed in the optical system, and in which light with a large depth (which plays a major role in image formation) and flares (blurred portions) are formed by the phase plate 113a. Since the image is dispersed and blurred portions are formed, the term “dispersion” has a meaning similar to that of “aberration”. Therefore, in the present embodiment, dispersion is sometimes explained as aberration.

The structure of the image processing device 140 and processes performed thereby will be described below.

As shown in FIG. 3, the image processing device 140 includes a RAW buffer memory 141, a convolution operator 142, a kernel data storage ROM 143 that functions as memory means, and a convolution controller 144.

The convolution controller 144 is controlled by the controller 190 so as to turn on/off the convolution process, control the screen size, and switch kernel data.

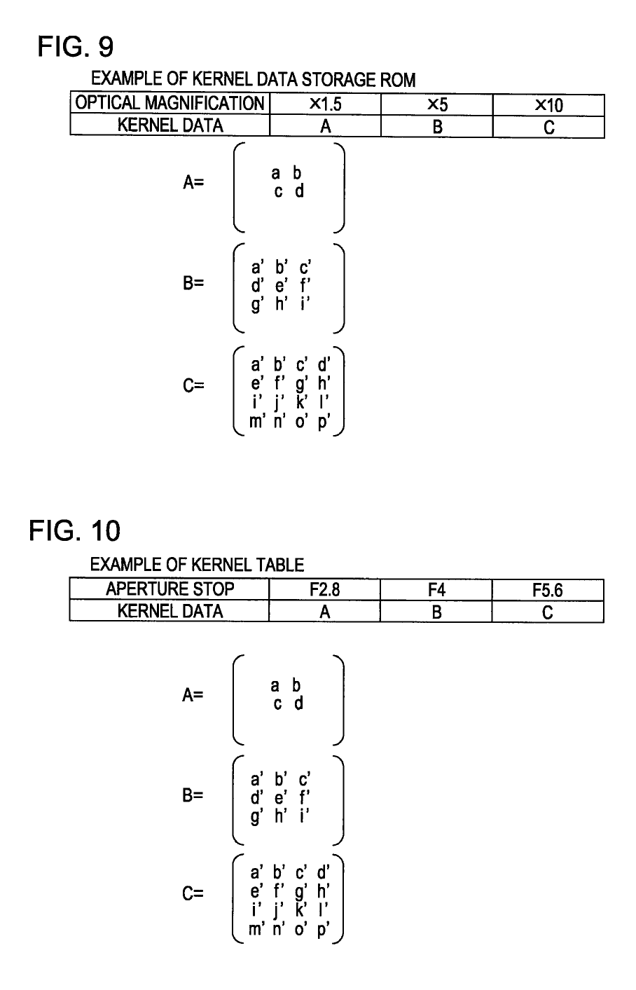

As shown in FIGS. 9, and 10, the kernel data storage ROM 143 stores kernel data for the convolution process that are calculated in advance on the basis of the PSF in of the optical system. The kernel data storage ROM 143 acquires exposure information, which is determined when the exposure settings are made by the controller 190, and the kernel data is selected through the convolution controller 144.

The exposure information includes aperture information.

In the example shown in FIG. 9, kernel data A corresponds to an optical magnification of 1.5, kernel data B corresponds to an optical magnification of 5, and kernel data C corresponds to an optical magnification of 10.

In the example shown in FIG. 10, kernel data A corresponds to an F number, which is the aperture information, of 2.8, kernel data B corresponds to an F number of 4, and kernel data C corresponds to an F number of 5.6.

The filtering process is performed in accordance with the aperture information, as in the example shown in FIG. 10, for the following reasons.

That is, when the aperture is stopped down to shoot an object, the phase plate 113a that functions as the optical wavefront modulation element is covered by the aperture stop. Therefore, the phase is changed and suitable image reconstruction cannot be performed.

Therefore, according to the present embodiment, a filtering process corresponding to the aperture information included in the exposure information is performed as in this example, so that suitable image reconstruction can be performed.

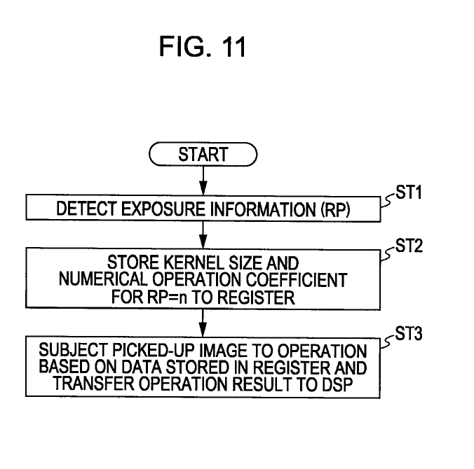

FIG. 11 is a flowchart of a switching process performed by the controller 190 in accordance with the exposure information (including the aperture information).

First, exposure information (RP) is detected and is supplied to the convolution controller 144 (ST101).

The convolution controller 144 sets the kernel size and the numerical operation coefficient in a register on the basis of the exposure information RP (ST102).

The image data obtained by the image pickup device 120 and input to the two-dimensional convolution operator 142 through the AFE unit 130 is subjected to the convolution operation based on the data stored in the register. Then, the data obtained by the operation is transmitted to the signal processor 150 (ST103).

The signal processor and the kernel data storage ROM of the image processing device 140 will be described in more detail below.

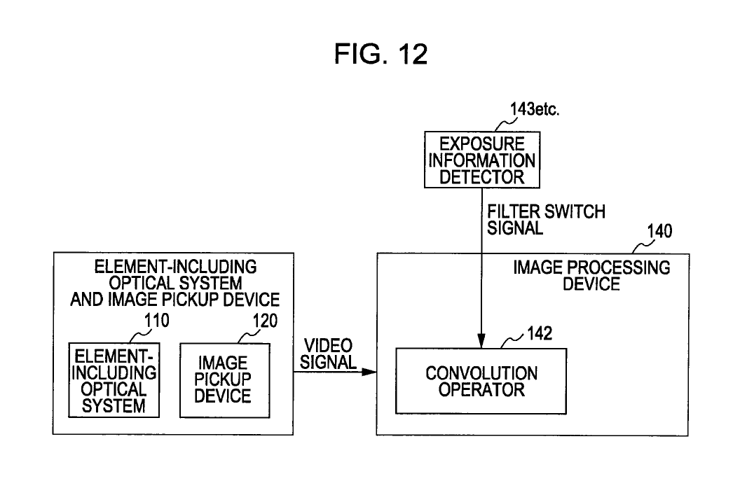

FIG. 12 a block diagram illustrating the first example of the structure of the image processing device including a signal processor and a kernel data storage ROM. For simplicity, the AFE unit and the like are omitted.

The example shown in FIG. 12 corresponds to the case in which filter kernel data is prepared in advance in association with the exposure information.

The image processing device 140 receives the exposure information that is determined when the exposure settings are made and selects kernel data through the convolution controller 144. The two-dimensional convolution operator 142 performs the convolution process using the kernel data.

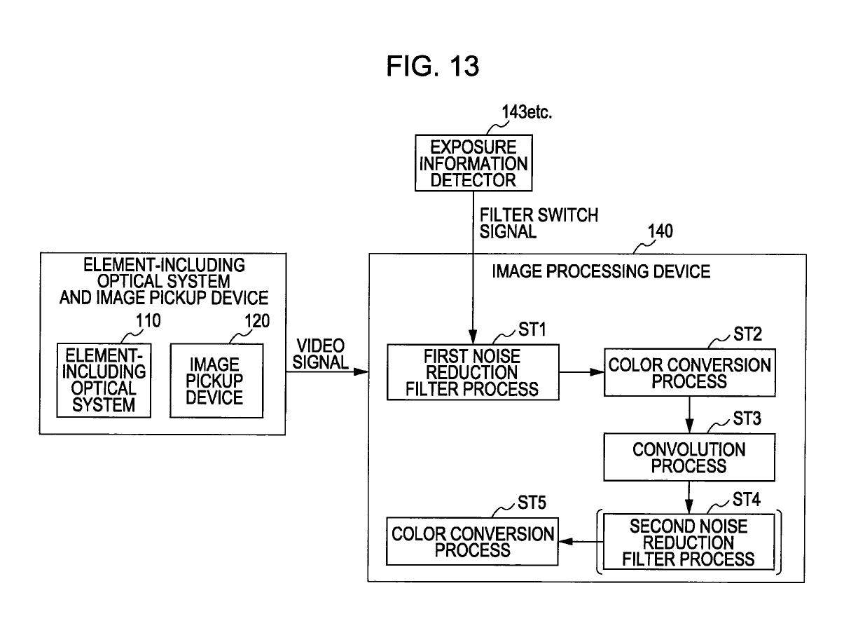

FIG. 13 a block diagram illustrating the second example of the structure of the image processing device including a signal processor and a kernel data storage ROM. For simplicity, the AFE unit and the like are omitted.

In the example shown in FIG. 13, the image processing device performs a noise-reduction filtering process first. The noise-reduction filtering process ST1 is prepared in advance as the filter kernel data in association with the exposure information.

The exposure information determined when the exposure settings are made is detected and the kernel data is selected through the convolution controller 144.

After the first noise-reduction filtering process ST1, the two-dimensional convolution operator 142 performs a color conversion process ST2 for converting the color space and then performs the convolution process ST3 using the kernel data.

Then, a second noise-reduction filtering process ST4 is performed and the color space is returned to the original state by a color conversion process ST5. The color conversion processes may be, for example, YCbCr conversion. However, other kinds of conversion processes may also be performed.

The second noise-reduction filtering process ST4 may be omitted.

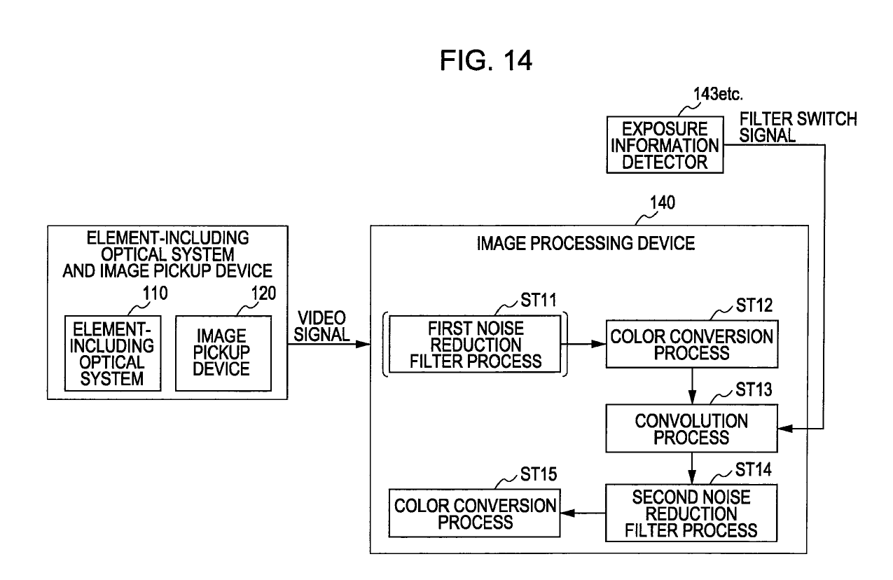

FIG. 14 a block diagram illustrating the third example of the structure of the image processing device including a signal processor and a kernel data storage ROM. For simplicity, the AFE unit and the like are omitted.

FIG. 14 is a block diagram illustrating the case in which an OTF reconstruction filter is prepared in advance in association with the exposure information.

The exposure information determined when the exposure settings are made is obtained and the kernel data is selected through the convolution controller 144.

After a noise-reduction filtering process ST11 and a color conversion process ST12, the two-dimensional convolution operator 142 performs a convolution process ST13 using the OTF reconstruction filter.

Then, a noise-reduction filtering process ST14 is performed and the color space is returned to the original state by a color conversion process ST15. The color conversion processes may be, for example, YCbCr conversion. However, other kinds of conversion processes may also be performed.

One of the noise-reduction filtering processes ST11 and ST14 may also be omitted.

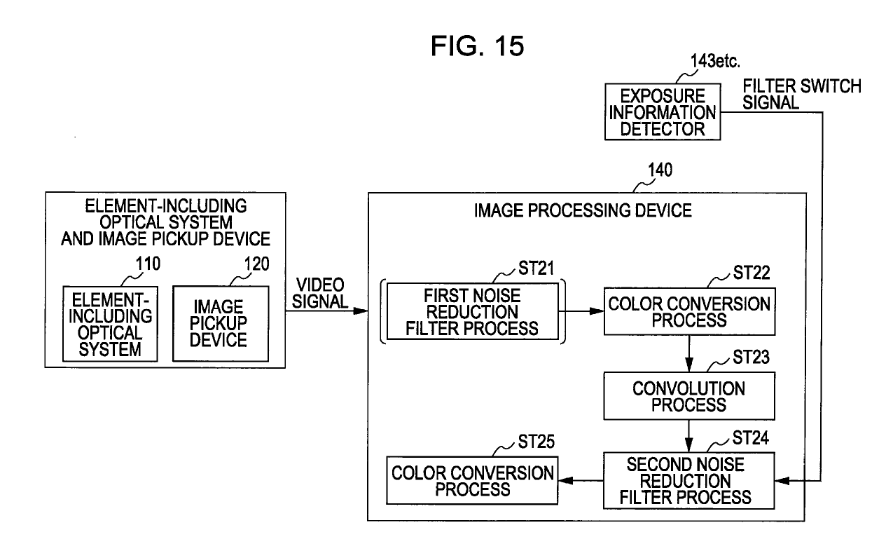

FIG. 15 is a block diagram illustrating the forth example of the structure of the image processing device including a signal processor and a kernel data storage ROM. For simplicity, the AFE unit and the like are omitted.

In the example shown in FIG. 15, noise-reduction filtering processes are performed and a noise reduction filter is prepared in advance as the filter kernel data in association with the exposure information.

A noise-reduction filtering process ST24 may also be omitted.

The exposure information determined when the exposure settings are made is acquired and the kernel data is selected through the convolution controller 144.

After a noise-reduction filtering process ST21, the two-dimensional convolution operator 142 performs a color conversion process ST22 for converting the color space and then performs the convolution process ST23 using the kernel data.

Then, the noise-reduction filtering process ST24 is performed in accordance with the exposure information and the color space is returned to the original state by a color conversion process ST25. The color conversion processes may be, for example, YCbCr conversion. However, other kinds of conversion processes may also be performed.

In the above-described examples, the filtering process is performed by the two-dimensional convolution operator 142 in accordance with only the exposure information. However, the exposure information may also be used in combination with, for example, object distance information, zoom information, or shooting-mode information so that a more suitable operation coefficient can be extracted or a suitable operation can be performed.

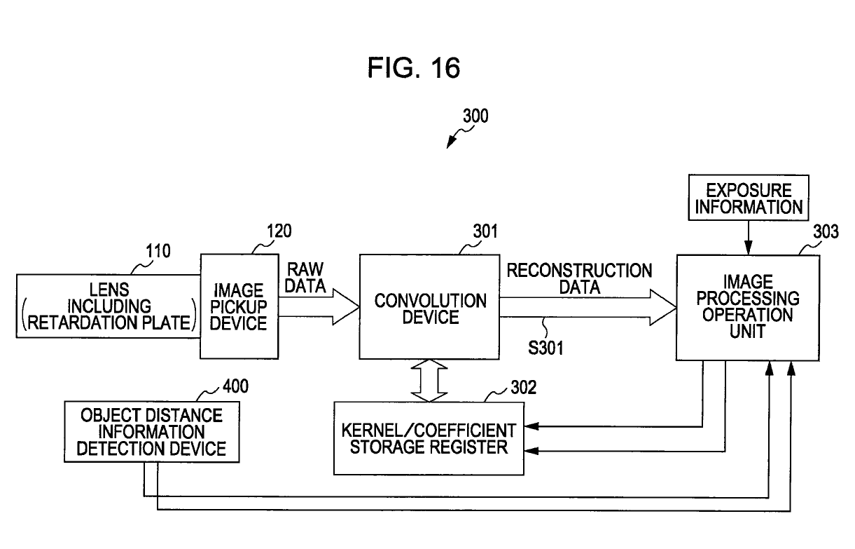

FIG. 16 shows an example of the structure of an image processing device in which the object distance information and the exposure information are used in combination. In the image processing device 300 shown in FIG. 16, an image pickup apparatus 120 generates an image signal with a smaller dispersion than that of a dispersed object-image signal obtained from an image pickup device 120.

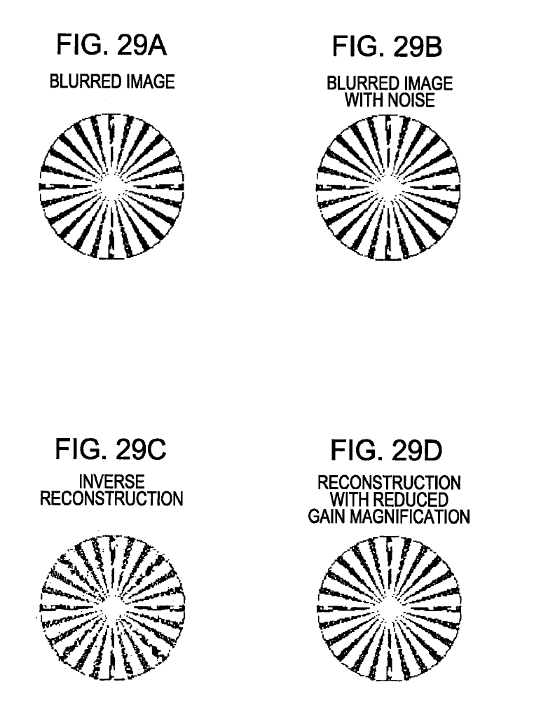

As shown in FIG. 29, the image processing device 300 includes a convolution device 301, a kernel/coefficient storage register 302, and an image processing operation unit 303.

In the image processing device 300, the image processing operation unit 303 reads information regarding an approximate distance to the object and exposure information from an object-distance-information detection device 400, and determines a kernel size and an operation coefficient for use in an operation suitable for the object position. The image processing operation unit 303 stores the kernel size and the operation coefficient in the kernel/coefficient storage register 302. The convolution device 301 performs the suitable operation using the kernel size and the operation coefficient so as to reconstruct the image.

In the image pickup apparatus including the phase plate (Wavefront Coding optical element) as the optical wavefront modulation element, as described above, a suitable image signal without aberration can be obtained by image processing when the focal distance is within a predetermined focal distance range. However, when the focal distance is outside the predetermined focal distance range, there is a limit to the correction that can be performed by the image processing. Therefore, the image signal includes aberrations for only the objects outside the above-described range.

When the image processing is performed such that aberrations do not occur in a predetermined small area, blurred portions can be obtained in an area outside the predetermined small area.

In this example, the distance to a main object is detected by the object-distance-information detection device 400 including a distance detection sensor. Then, different image correction processes are performed in accordance with the detected distance.

The above-described image processing is performed by the convolution operation. To achieve the convolution operation, a single common operation coefficient may be stored and a correction coefficient may be stored in association with the focal distance. In such a case, the operation coefficient is corrected using the correction coefficient so that a suitable convolution operation can be performed using the corrected operation coefficient.

Alternatively, the following structures may also be used.

That is, a kernel size and an operation coefficient for the convolution operation may be directly stored in advance in association with the focal distance, and the convolution operation may be performed using the thus-stored kernel size and operation coefficient. Alternatively, the operation coefficient may be stored in advance as a function of focal distance. In this case, the operation coefficient to be used in the convolution operation may be calculated from this function in accordance with the focal distance.

In the apparatus shown in FIG. 16, the following structure may be used.

That is, the register 302 functions as conversion-coefficient storing means and stores at least two conversion coefficients corresponding to the aberration caused by at least the phase plate 113a in association with the object distance. The image processing operation unit 303 functions as coefficient-selecting means for selecting a conversion coefficient which is stored in the register 302 and which corresponds to the object distance on the basis of information generated by the object-distance-information detection device 400 that functions as object-distance-information generating means.

Then, the convolution device 301, which functions as converting means, converts the image signal using the conversion coefficient selected by the image processing operation unit 303 which functions as the coefficient-selecting means.

Alternatively, as described above, the image processing operation unit 303 functions as conversion-coefficient calculating means and calculates the conversion coefficient on the basis of the information generated by the object-distance-information detection device 400 which functions as the object-distance-information generating means. The thus-calculated conversion coefficient is stored in the register 302.

Then, the convolution device 301, which functions as the converting means, converts the image signal using the conversion coefficient obtained by the image processing operation unit 303 which functions as the conversion-coefficient calculating means and stored in the register 302.

Alternatively, the 302 functions as correction-value storing means and stores at least one correction value in association with a zoom position or an amount of zoom of the element-including zoom optical system 110. The correction value includes a kernel size of an object aberration image.

The register 302 also functions as second conversion-coefficient storing means and stores a conversion coefficient corresponding to the aberration caused by the phase plate 113a in advance.

Then, the image processing operation unit 303 functions as correction-value selecting means and selects a correction value, which corresponds to the object distance, from one or more correction values stored in the register 302 that functions as the correction-value storing means on the basis of the distance information generated by the object-distance-information detection device 400 that functions as the object-distance-information generating means.

Then, the convolution device 301, which functions as the converting means, converts the image signal using the conversion coefficient obtained from the register 302, which functions as the second conversion-coefficient storing means, and the correction value selected by the image processing operation unit 303 which functions as the correction-value selecting means.

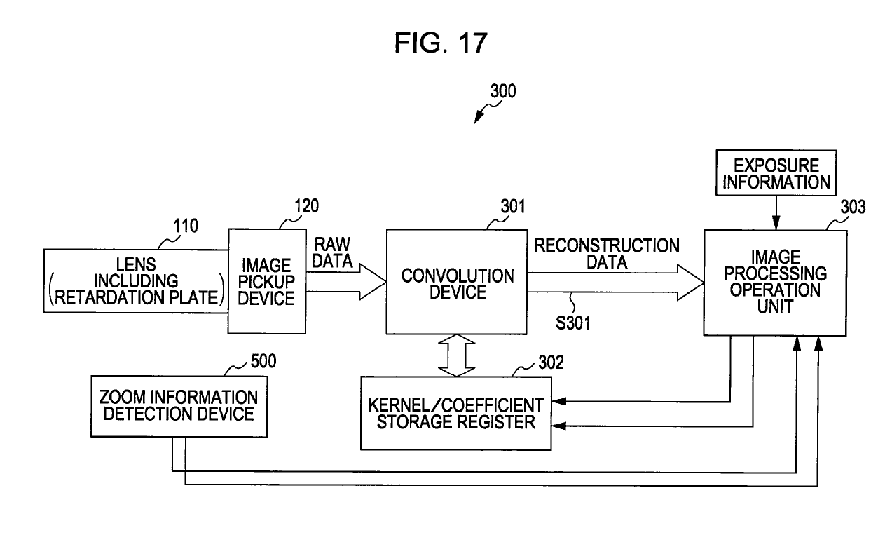

FIG. 17 shows an example of the structure of an image processing device in which zoom information and exposure information are used in combination.

Referring to FIG. 17, an image processing device 300A generates an image signal with a smaller dispersion than that of a dispersed object-image signal obtained from an image pickup device 120.

Similar to the image processing device shown in FIG. 16, the image processing device 300A shown in FIG. 17 includes a convolution device 301, a kernel/coefficient storage register 302, and an image processing operation unit 303.

In the image processing device 300A, the image processing operation unit 303 reads information regarding the zoom position or the amount of zoom and the exposure information from the zoom information detection device 500. The kernel/coefficient storage register 302 stores kernel size data and operation coefficient data which are used in a suitable operation for exposure information and a zoom position. Accordingly, the convolution device 301 performs a suitable operation so as to reconstruct the image.

As described above, in the case in which the phase plate, which functions as the optical wavefront modulation element, is included in the zoom optical system of the image pickup apparatus, the generated spot image differs in accordance with the zoom position of the zoom optical system. Therefore, in order to obtain a suitable in-focus image by subjecting an out-of-focus image (spot image) obtained by the phase plate to the convolution operation performed by the DSP or the like, the convolution operation that differs in accordance with the zoom position must be performed.

Accordingly, in the present embodiment, the zoom information detection device 500 is provided so that a suitable convolution operation can be performed in accordance with the zoom position and a suitable in-focus image can be obtained irrespective of the zoom position.

In the convolution operation performed by the image processing device 300A, a signal, common operation coefficient for the convolution operation may be stored in the register 302.

Alternatively, the following structures may also be used:

a structure in which a correction coefficient is stored in advance in the register 302 in association with the zoom position, and the operation coefficient may be corrected using the correction coefficient, and a suitable convolution operation is performed using a corrected operation coefficient;

a structure in which a kernel size or an operation coefficient for the convolution operation are stored in advance in the register 302 in association with the zoom position, and the convolution operation is performed using the thus-stored kernel size or the stored convolution operation coefficient; and

a structure in which an operation coefficient is stored in advance in the register 302 as a function of zoom position, and the convolution operation is performed on the basis of a calculated operation coefficient.

More specifically, in the apparatus shown in FIG. 17, the following structure may be used.

The register 302 functions as conversion-coefficient storing means and stores at least two conversion coefficients corresponding to the aberration caused by the phase plate 113a in association with the zoom position or the amount of zoom in the element-including zoom optical system 110. The image processing operation unit 303 functions as coefficient-selecting means for selecting one of the conversion coefficients stored in the register 302. More specifically, the image processing operation unit 303 selects a conversion coefficient that corresponds to the zoom position or the amount of zoom of the element-including zoom optical system 110 on the basis of information generated by the zoom information detection device 500 that functions as zoom-information generating means.

Then, the convolution device 301, which functions as converting means, converts the image signal using the conversion coefficient selected by the image processing operation unit 303 which functions as the coefficient-selecting means.

Alternatively, as described above, the image processing operation unit 303 functions as conversion-coefficient calculating means and calculates the conversion coefficient on the basis of the information generated by the zoom information detection device 500 which functions as the zoom-information generating means. The thus-calculated conversion coefficient is stored in the kernel/coefficient storage register 302.

Then, the convolution device 301, which functions as the converting means, converts the image signal on the basis of the conversion coefficient obtained by the image processing operation unit 303, which functions as the conversion-coefficient calculating means, and stored in the register 302.

Alternatively, the storage register 302 functions as correction-value storing means and stores at least one correction value in association with the zoom position or the amount of zoom of the zoom optical system 110. The correction value includes a kernel size of an object aberration image.

The register 302 also functions as second conversion-coefficient storing means and stores a conversion coefficient corresponding to the aberration caused by the phase plate 113a in advance.

Then, the image processing operation unit 303 functions as correction-value selecting means and selects a correction value, which corresponds to the zoom position or the amount of zoom of the element-including zoom optical system, from one or more correction values stored in the register 302, which functions as the correction-value storing means, on the basis of the zoom information generated by the zoom information detection device 500 that functions as the zoom-information generating means.

The convolution device 301, which functions as the converting means, converts the image signal using the conversion coefficient obtained from the register 302, which functions as the second conversion-coefficient storing means, and the correction value selected by the image processing operation unit 303, which functions as the correction-value selecting means.

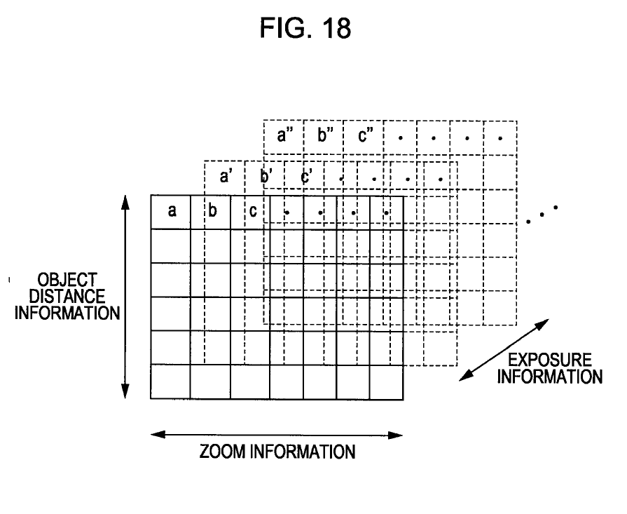

FIG. 18 shows an example of a filter structure used when the exposure information, the object distance information, and the zoom information are used in combination. In this example, two-dimensional information structure is formed by the object distance information and the zoom information, and the exposure information elements are arranged along the depth.

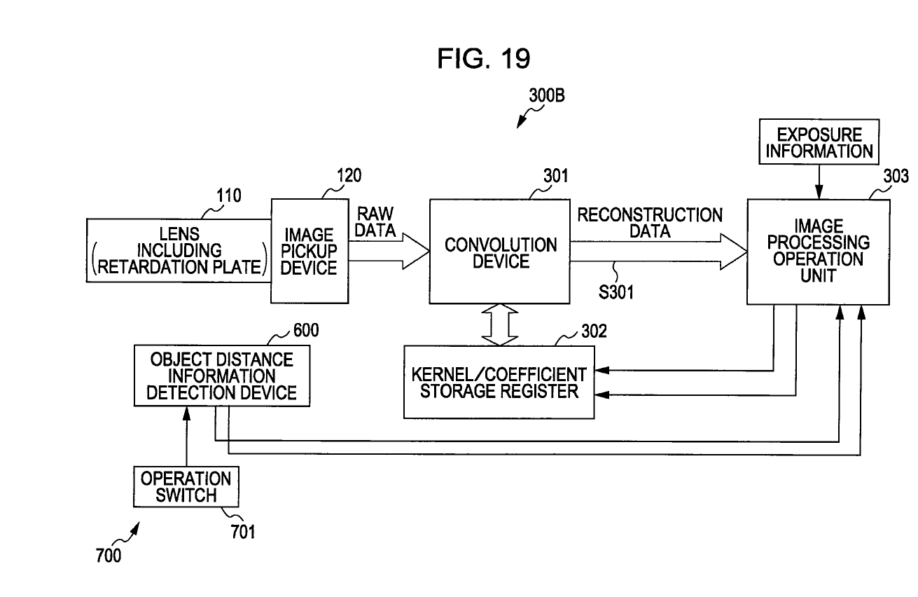

FIG. 19 is a diagram illustrating the structure of an image processing device in which shooting-mode information and exposure information are used in combination.

FIG. 19 illustrates the structure of an image processing device 300B that generates an image signal with a smaller dispersion than that of a dispersed object image signal from an image pickup device 120.

Similar to the image processing device shown in FIGS. 16 and 17, the image processing device 300A in FIG. 19 includes a convolution device 301, a kernel/coefficient storage register 302 that functions as a storing means, and an image processing operation unit 303.

In this image processing device 300B, an image processing operation unit 303 receives information regarding an approximate distance to the object that is read from an object-distance-information detection device 600 and exposure information. Then, the image processing operation unit 303 stores a kernel size and an operation coefficient suitable for the object distance in the kernel/coefficient storage register 302, and the convolution device 301 performs a suitable operation using the thus-stored values to reconstruct the image.

In the image pickup apparatus including the phase plate (Wavefront Coding optical element) as the optical wavefront modulation element, as described above, a suitable image signal without aberration can be obtained by image processing when the focal distance is within a predetermined focal distance range. However, when the focal distance is outside the predetermined focal distance range, there is a limit to the correction that can be performed by the image processing. Therefore, the image signal includes aberrations for only the objects outside the above-described range.

When the image processing is performed such that aberrations do not occur in a predetermined small area, blurred portions can be obtained in an area outside the predetermined small area.

In this example, the distance to the main object is detected by the object-distance-information detection device 600 including a distance detection sensor. Then, different image correction processes are performed in accordance with the detected distance.

The above-described image processing is performed by the convolution operation. To achieve the convolution operation, a single, common operation coefficient may be stored and a correction coefficient may be stored in association with the focal distance. In such a case, the operation coefficient is corrected using the correction coefficient so that a suitable convolution operation can be performed using the corrected operation coefficient.

Alternatively, an operation coefficient is stored in advance as a function in association with the focal distance. The operation coefficient is calculated for a focal distance using the function. The convolution operation is performed on the basis of a calculated operation coefficient.

Alternatively, the operation coefficient may be stored in advance as a function of focal distance. In this case, the operation coefficient to be used in the convolution operation may be calculated from this function in accordance with the focal distance.

Alternatively, a kernel size or an operation coefficient for the convolution operation are stored in advance in association with the zoom position, and the convolution operation is performed using the thus-stored kernel size or the stored convolution operation coefficient.

In the present embodiment, as described above, the image processing operation is changed in accordance with mode setting (portrait, infinity (landscape), or macro) of the DSC.

For the apparatus shown in FIG. 17, the following structure may be used.

As described above, the image processing operation unit 303, which functions as the conversion-coefficient calculating means, stores different conversion coefficients in the register 302, which functions as the conversion-coefficient storing means, in accordance with the shooting mode set by a shooting-mode setting unit 700 included in the operating unit 180. The image processing operation unit 303 extracts a conversion coefficient corresponding to the information generated by the object-distance-information detection device 600, which functions as the object-distance-information generating means. The conversion coefficient is extracted from the register 302, which functions as the conversion-coefficient storing means, in accordance with the shooting mode set by an operation switch 701 of the shooting-mode setting unit 700. At this time, the image processing operation unit 303, for example, functions as conversion-coefficient extracting means. Then, the convolution device 301, which functions as the converting means, performs the converting operation corresponding to the shooting mode of the image signal using the conversion coefficient extracted from the register 302.

FIGS. 4 and 5 show an example of an optical system, and an optical system according to the present invention is not limited to that shown in FIGS. 4 and 5. In addition, FIGS. 6 and 7 show examples of spot shapes, and the spot shapes of the present embodiment are not limited to those shown in FIGS. 6 and 7.

The kernel data storage ROM is not limit to those storing the kernel sizes and values in association with the optical magnification, the F number, and kernel sizes and values thereof, as shown in FIGS. 9 and 10. In addition, the number of kernel data elements to be prepared is not limited to three.

Although the amount of information to be stored is increased as the number of dimensions thereof, as shown in FIG. 18, is increase to three or more, a more suitable selection can be performed on the basis of various conditions in such a case. The information to be stored includes the exposure information, the object distance information, the zoom information, the shooting mode, etc., as described above.

In the image pickup apparatus including the phase plate (Wavefront Coding optical element) as the optical wavefront modulation element, as described above, a suitable image signal without aberration can be obtained by image processing when the focal distance is within a predetermined focal distance range. However, when the focal distance is outside the predetermined focal distance range, there is a limit to the correction that can be performed by the image processing. Therefore, the image signal includes aberrations for only the objects outside the above-described range.

In the present embodiment, the wavefront-aberration-control optical system is used so that a high-definition image can be obtained, the structure of the optical system can be simplified, and the costs can be reduced.

Features of the DEOS will be described in more detail below.

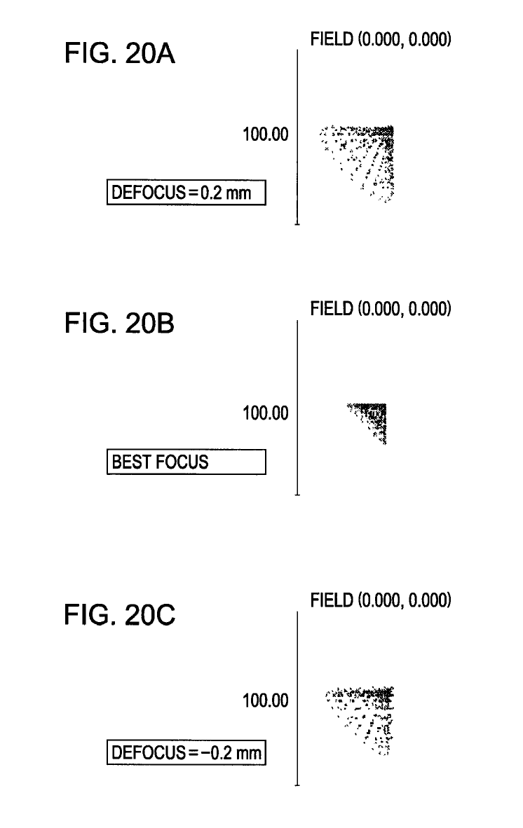

FIGS. 20A to 20C show spot images formed on the light-receiving surface of the image pickup device 120.

FIG. 20A shows the spot image obtained when the focal point is displaced by 0.2 mm (Defocus=0.2 mm), FIG. 20B shows the spot image obtained when the focal point is not displaced (Best focus), and FIG. 20C shows the spot image obtained when the focal point is displaced by −0.2 mm (Defocus=−0.2 mm).

As is clear from FIGS. 20A to 20C, in the image pickup apparatus 100 according to the present embodiment, light with a large depth (which plays a major role in image formation) and flares (blurred portions) are formed by the phase plate 113a.

Thus, the first image FIM formed by the image pickup apparatus 100 according to the present embodiment is in light conditions with an extremely large depth.

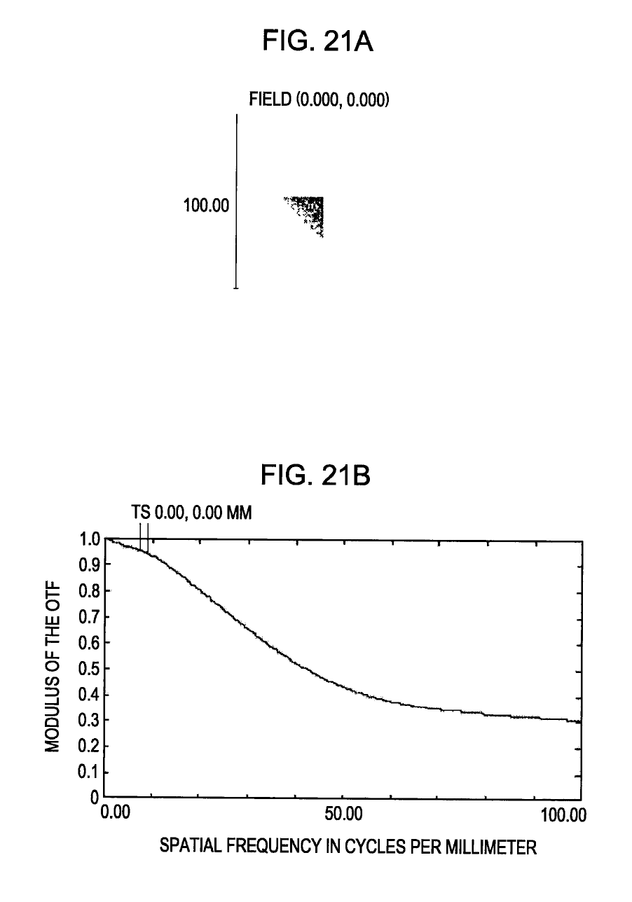

FIGS. 21A and 21B are diagrams for explaining a Modulation Transfer Function (MTF) of the first image formed by the image pickup apparatus according to the present embodiment. FIG. 21A shows a spot image formed on the light-receiving surface of the image pickup device included in the image pickup apparatus. FIG. 21B shows the MTF characteristic with respect to spatial frequency.

In the present embodiment, a final, high-definition image is obtained by a correction process performed by the image processing device 140 including, for example, a Digital Signal Processor (DSP). Therefore, as shown in FIGS. 21A and 21B, the MTF of the first image is basically low.

The image processing device 140 is, as described above, form a final high-definition image FNLIM

The image processing device 140 receives a first image FIM from the image pickup device 120 and subjects the first image to a predetermined correction process for lifting the MTF relative to the special frequency so as to obtain a final high-definition image FNLIM.

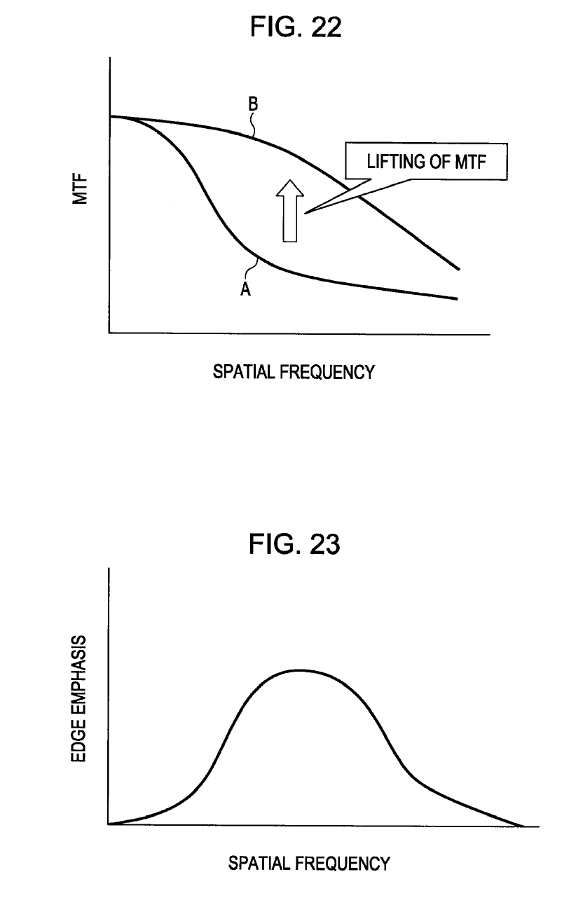

In the MTF correction process performed by the image processing device 140, the MTF of the first image, which is basically low as shown by the curve A in FIG. 22, is changed to an MTF closer to, or the same as, that shown by the curve B in FIG. 22 by performing prost-processing including edge emphasis and chroma emphasis using the spatial frequency as a parameter. The characteristic shown by the curve B in FIG. 22 is obtained when, for example, the wavefront shape is not changed using the wavefront coding optical element as in the present embodiment.

In the present embodiment, all of the corrections are performed using the spatial frequency as a parameter.

In the present embodiment, in order to obtain the final MTF characteristic curve B from the optically obtained MTF characteristic curve A with respect to the special frequency as shown in FIG. 22, the original image (first image) is corrected by performing edge emphasis or the like for each spatial frequency. For example, the MTF characteristic shown in FIG. 22 is processed with an edge emphasis curve with respect to the spatial frequency shown in FIG. 23.

More specifically, in a predetermined spatial frequency range, the degree of edge emphasis is reduced at a low-frequency side and a high-frequency side and is increased in an intermediate frequency region. Accordingly, the desired MTF characteristic curve B can be virtually obtained.

As described above, basically, the image pickup apparatus 100 according to the present embodiment includes the optical system 110 and the image pickup device 120 for obtaining the first image. In addition, the image pickup apparatus 100 also includes the image processing device 140 for forming the final high-definition image from the first image. The optical system is provided with a wavefront coding optical element or an optical element, such as a glass element and a plastic element, having a surface processed so as to perform wavefront formation, so that the wavefront of light can be changed (modulated). The light with the modulated wavefront forms an image, i.e., the first image, on the imaging plane (light-receiving surface) of the image pickup device 120 including a CCD or a CMOS sensor. The image pickup apparatus 100 according to the present embodiment is characterized in that the image pickup apparatus 100 functions as an image-forming system that can obtain a high-definition image from the first image through the image processing device 140.

In the present embodiment, the first image obtained by the image pickup device 120 is in light conditions with an extremely large depth. Therefore, the MTF of the first image is basically low, and is corrected by the image processing device 140.

The image-forming process performed by the image pickup apparatus 100 according to the present embodiment will be discussed below from the wave-optical point of view.

When a spherical wave emitted from a single point of an object passes through an imaging optical system, the spherical wave is converted into a convergent wave. At this time, aberrations are generated unless the imaging optical system is an ideal optical system. Therefore, the wavefront shape is changed into a complex shape instead of a spherical shape. Wavefront optics is the science that connects geometrical optics with wave optics, and is useful in dealing with the phenomenon of wavefront.

When the wave-optical MTF at the focal point is considered, information of the wavefront at the exit pupil position in the imaging optical system becomes important.

The MTF can be calculated by the Fourier transform of wave-optical intensity distribution at the focal point. The wave-optical intensity distribution is obtained as a square of wave-optical amplitude distribution, which is obtained by the Fourier transform of a pupil function at the exit pupil.

The pupil function is the wavefront information (wavefront aberration) at the exit pupil position. Therefore, the MTF can be calculated if the wavefront aberration of the optical system 110 can be accurately calculated.

Accordingly, the MTF value at the imaging plane can be arbitrary changed by changing the wavefront information at the exit pupil position by a predetermined process. Also in the present embodiment in which the wavefront shape is changed using the wavefront coding optical element, desired wavefront formation is performed by varying the phase (the light path length along the light beam). When the desired wavefront formation is performed, light output from the exit pupil forms an image including portions where light rays are dense and portions where light rays are sparse, as is clear from the geometrical optical spot images shown in FIGS. 20A to 20C. In this state, the MTF value is low in regions where the spatial frequency is low and an acceptable resolution is obtained in regions where the spatial frequency is high. When the MTF value is low, in other words, when the above-mentioned geometrical optical spot images are obtained, aliasing does not occur. Therefore, it is not necessary to use a low-pass filter. Then, flare images, which cause the reduction in the MTF value, are removed by the image processing device 140 including the DSP or the like. Accordingly the MTF value can be considerably increased.

Next, an MTF response of the present embodiment and that of a known optical system will be discussed below.

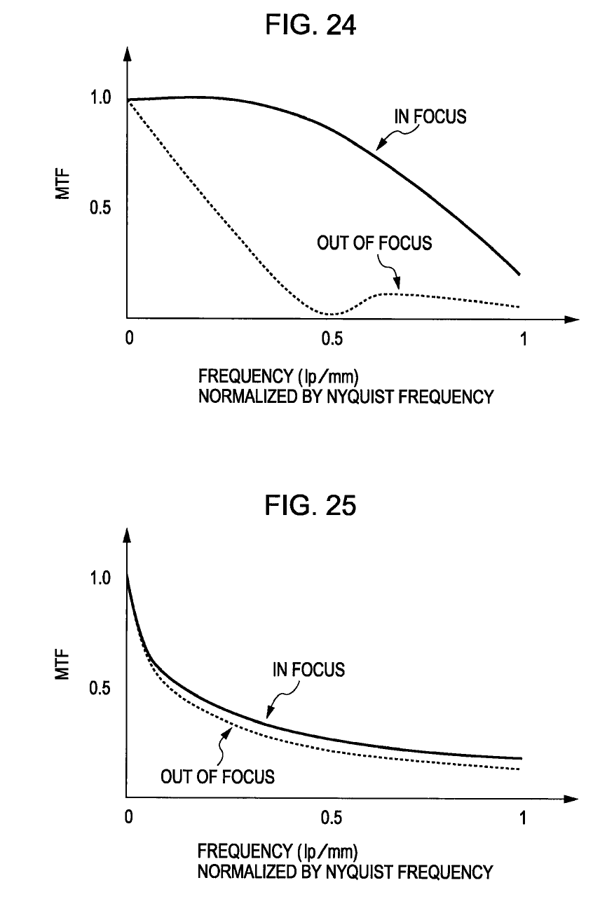

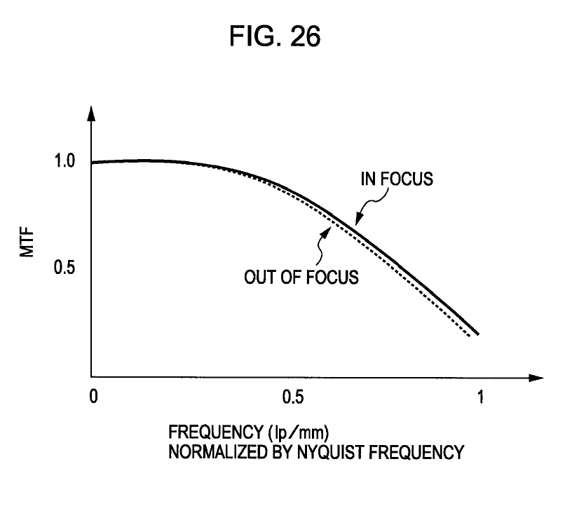

FIG. 24 is a diagram illustrating the MTF response obtained when an object is in focus and when the object is out of focus in the known optical system. FIG. 25 is a diagram illustrating the MTF response obtained when an object is in focus and when the object is out of focus in the optical system including an optical wavefront modulation element according to the embodiment. FIG. 26 is a diagram illustrating the MTF response obtained after data reconstruction in the image pickup apparatus according to the embodiment.

In the optical system including the optical wavefront modulation element, variation in the MTF response obtained when the object is out of focus is smaller than that in an optical system free from the optical wavefront modulation element. The MTF response is increased by subjecting the image formed by the optical system including the optical wavefront modulation element to a process using a convolution filter.

As described above, according to the present embodiment, the image pickup apparatus includes the optical system 110 and the image pickup device 120 for forming a first image. In addition, the image pickup apparatus also includes the image processing device 140 for forming a final high-definition image from the first image. A filtering process of the optical transfer function (OTF) on the basis of the information obtained from the image processing device 140 and exposure information obtained from the controller 190 is performed. Therefore, the optical system can be simplified and the costs can be reduced. Furthermore, a high-quality reconstruction image in which the influence of noise is small can be obtained.

In addition, the kernel size and the operation coefficient used in the convolution operation are variable, and suitable kernel size and operation coefficient can be determined on the basis of the inputs from the operating unit 180 and the like. Accordingly, it is not necessary to take the magnification and defocus area into account in the lens design and the reconstructed image can be obtained by the convolution operation with high accuracy.

In addition, a natural image in which the object to be shot is in focus and the background is blurred can be obtained without using a complex, expensive, large optical lens or driving the lens.

The image pickup apparatus 100 according to the present embodiment may be applied to a small, light, inexpensive wavefront-aberration-control optical system for use in consumer appliances such as digital cameras and camcorders.

In addition, in the present embodiment, the image pickup apparatus 100 includes the element-including optical system 110 and the image processing device 140. The element-including optical system 110 includes the wavefront coding optical element for changing the wavefront shape of light that passes through the imaging lens 112 to form an image on the light-receiving surface of the image pickup device 120.

The image processing device 140 receives a first image FIM from the image pickup device 120 and subjects the first image to a predetermined correction process for lifting the MTF relative to the special frequency so as to obtain a final high-definition image FNLIM. Thus, there is an advantage in that a high-definition image can be obtained.

In addition, the structure of the optical system 110 can be simplified and the optical system 110 can be easily manufactured. Furthermore, the costs can be reduced.

In the case in which a CCD or a CMOS sensor is used as the image pickup device, the resolution has a limit determined by the pixel pitch. If the resolution of the optical system is equal to or more than the limit, phenomenon like aliasing occurs and adversely affects the final image, as is well known.

Although the contrast is preferably set as high as possible to improve the image quality, a high-performance lens system is required to increase the contrast.

However, aliasing occurs, as described above, in the case in which a CCD or a CMOS sensor is used as the image pickup device.

In the known image pickup apparatus, to avoid the occurrence of aliasing, a low-pass filter composed of a uniaxial crystal system is additionally used.

Although the use of the low-pass filter is basically correct, since the low-pass filter is made of crystal, the low-pass filter is expensive and is difficult to manage. In addition, when the low-pass filter is used, the structure of the optical system becomes more complex.

As described above, although images with higher definitions are demanded, the complexity of the optical system must be increased to form high-definition images in the known image pickup apparatus. When the optical system becomes complex, the manufacturing process becomes difficult. In addition, when an expensive low-pass filter is used, the costs are increased.

In comparison, according to the present embodiment, aliasing can be avoided and high-definition images can be obtained without using the low-pass filter.

In the element-including optical system according to the present embodiment, the wavefront coding optical element is positioned closer to the object-side lens than the aperture. However, the he wavefront coding optical element may also be disposed at the same position as the aperture or at a position closer to the imaging lens than the aperture. Also in such a case, effects similar to those described above can be obtained.

FIGS. 4 and 5 show an example of an optical system, and an optical system according to the present invention is not limited to that shown in FIGS. 4 and 5. In addition, FIGS. 6 and 7 show examples of spot shapes, and the spot shapes of the present embodiment are not limited to those shown in FIGS. 6 and 7.

The kernel data storage ROM is not limit to those storing the kernel sizes and values in association the optical magnification, the F number, and the object distance information, as shown in FIGS. 9, 22, and 10. In addition, the number of kernel data elements to be prepared is not limited to three.

When an image obtained by shooting an object in a dark place, for example, is reconstructed by signal processing, noise is amplified at the same time.

Therefore, in the optical system which uses both an optical unit and signal processing, that is, in which an optical wavefront modulation element, such as the above-described phase plate, is used and signal processing is performed, noise is amplified and the reconstructed image is influenced when an object is shot in a dark place. phase modulation device.

Accordingly, if the size and value of the filter used in the image processing device and the gain magnification are variable and if a suitable operation coefficient is selected in accordance with the exposure information, a reconstruction image in which the influence of noise is small can be obtained.

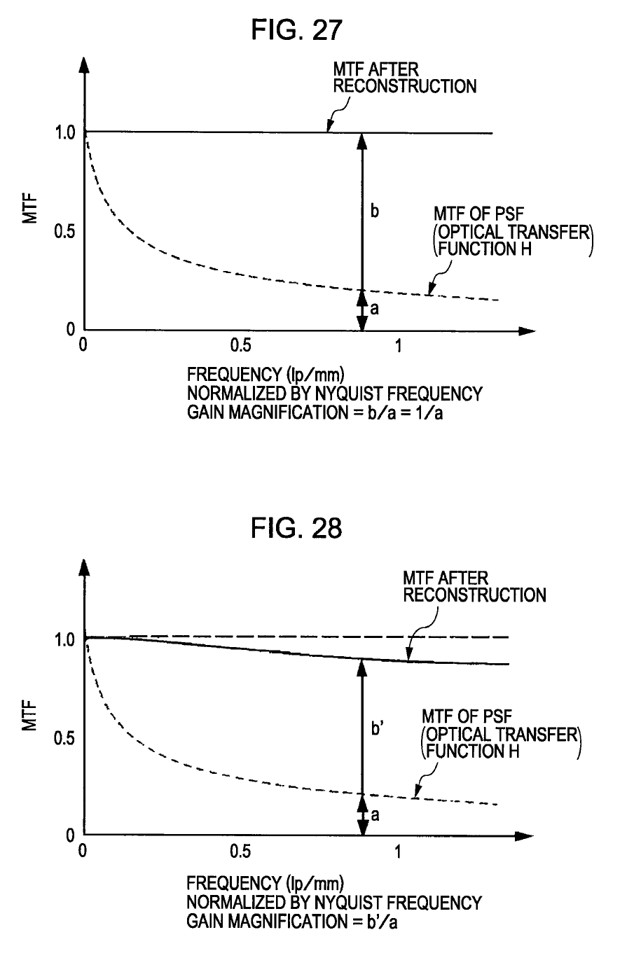

For example, a case is considered in which a blurred image obtained by a digital camera while the shooting mode thereof is set to a night scene mode is subjected to a frequency modulation with inverse reconstruction 1/H of the optical transfer function H shown in FIG. 27. In such a case, noise (in particular, high-frequency components) multiplied by a gain with the ISO sensitivity is also subjected to the frequency modulation. Therefore, the noise components are emphasized and remain noticeable in the reconstructed image. This is because if an image obtained by shooting an object in a dark place is reconstructed by signal processing, noise is amplified at the same time and the reconstructed image is affected accordingly. Here, the gain magnification will be explained. The gain magnification is a magnification used when the frequency modulation of an MTF is performed using a filter. More specifically, the gain magnification is an amount of lift of the MTF at a certain frequency. If a is the MTF value of the blurred image and b is the MTF value of the reconstructed image, the gain magnification can be calculated as b/a. For example, in the case in which the reconstructed image is a point image (MTF is 1) as shown in FIG. 27, the gain magnification is calculated as 1/a.

Thus, according to another characteristic of the present invention, the frequency modulation is performed with the gain magnification that is reduced in a high-frequency range, as shown in FIG. 28. Accordingly, compared to the case shown in FIG. 27, the frequency modulation of, in particular, high-frequency noise is suppressed and an image in which the noise is further reduced can be obtained. In this case, as shown in FIG. 28, if a is the MTF value of the blurred image and b′ (b′<b) is the MTF value of the reconstructed image, the gain magnification is calculated as b′/a, which is smaller than that when the inverse reconstruction is performed. Thus, if the amount of exposure is reduced in the case of, for example, shooting an object in a dark place, the gain magnification in the high-frequency range can be reduced, so that a suitable operation coefficient can be used. As a result, a reconstruction image in which the influence of noise is small can be obtained.

FIGS. 29A to 29D are diagrams illustrating the results of simulation of the above-described noise reduction effect. FIG. 29A shows a blurred image, FIG. 29B shows a blurred image to which noise is added, FIG. 29C shows the result of inverse reconstruction of the image shown in FIG. 29B, and FIG. 29D is the result of reconstruction with the reduced gain magnification.

These figures show that the influence of noise can be reduced in the result of reconstruction using the reduced gain magnification. The reduction in the gain magnification leads to a slight reduction in contrast. However, the contrast can be increased by performing post-processing such as edge emphasis.

According to the present invention, the structure of the optical system can be simplified, and the costs can be reduced. In addition, a high-quality reconstruction image in which the influence of noise is small can be obtained. Therefore, the image pickup apparatus and the image processing method may be preferably used for a digital still camera, a mobile phone camera, a Personal Digital Assistant camera, an image inspection apparatus, an industrial camera used for automatic control.

1. An image pickup apparatus comprising:
an optical system;
an image pickup device picking up an object image that passes through said optical system;
a signal processor performing a predetermined operation of an image signal from said image pickup device with reference to an operation coefficient
a memory for storing an operation coefficient used by said signal processor; and
an exposure control unit controlling an exposure, wherein said signal processor performs a filtering process of the optical transfer function (OTF) on the basis of exposure information obtained from said exposure control unit.

2. The image pickup apparatus according to claim 1, wherein said optical system comprises an optical wavefront modulation element and converting means for generating an image signal with a smaller dispersion than that of a signal of a dispersed object image output from said image pickup device.

3. The image pickup apparatus according to claim 1, wherein said optical system comprises converting means for generating an image signal with a smaller dispersion than that of a signal of a dispersed object image output from said image pickup device.

4. The image pickup apparatus according to claim 1, wherein said signal processor comprises noise-reduction filtering means.

5. The image pickup apparatus according to claim 1, wherein said memory stores an operation coefficient used by said signal processor for performing a noise reducing process in accordance with exposure information.

6. The image pickup apparatus according to claim 1, wherein said memory stores an operation coefficient used for performing an optical-transfer-function (OTF) reconstruction process in accordance with exposure information.

7. The image pickup apparatus according to claim 6, wherein, in the OTF reconstruction process, frequency is modulated by changing the gain magnification in accordance with the exposure information.

8. The image pickup apparatus according to claim 7, wherein, when the exposure is low, the gain magnification of high frequency is reduced.

9. The image pickup apparatus according to claim 1, further comprising
a variable aperture controlled by said an exposure control unit.

10. The image pickup apparatus according to claim 1,
wherein the exposure information comprises aperture information.

11. The image pickup apparatus according to claim 2, further comprising:
object-distance-information generating means for generating information corresponding to a distance to an object, wherein the converting means generates the image signal with a smaller dispersion than that of a signal of the dispersed object on the basis of the information generated by the object-distance-information generating means.

12. The image pickup apparatus according to claim 11, further comprising:
conversion-coefficient storing means for storing at least two conversion coefficients corresponding to dispersion caused by at least said optical wavefront modulation element or said optical system in association with the distance to the object; and
coefficient-selecting means for selecting a conversion coefficient that corresponds to the distance to the object from the conversion coefficients in said conversion-coefficient storing means on the basis of the information generated by said object-distance-information generating means,
wherein said converting means generates the image signal on the basis of the conversion coefficient selected by said coefficient-selecting means.

13. The image pickup apparatus according to claim 11, further comprising:
conversion-coefficient calculating means for calculating a conversion coefficient on the basis of the information generated by said object-distance-information generating means,
wherein said converting means generates the image signal on the basis of the conversion coefficient obtained by said conversion-coefficient calculating means.

14. The image pickup apparatus according to claim 2, further comprises:
a zoom optical system;
correction-value storing means for storing one or more correction values in association with a zoom position or an amount of zoom of said zoom optical system;
second conversion-coefficient storing means for storing a conversion coefficient corresponding to dispersion caused by at least said optical wavefront modulation element or said optical system; and
correction-value selecting means for selecting a correction value that corresponds to the distance to the object from the correction values in said correction-value storing means on the basis of the information generated by said object-distance-information generating means,
wherein said converting means generates the image signal on the basis of the conversion coefficient obtained by said second conversion-coefficient storing means and the correction value selected by said correction-value selecting means.

15. The image pickup apparatus according to claim 14, wherein each of the correction values includes a kernel size of the dispersed object image.

16. The image pickup apparatus according to claim 2, further comprising:
object-distance-information generating means for generating information corresponding to a distance to an object; and
conversion-coefficient calculating means for calculating a conversion coefficient on the basis of the information generated by said object-distance-information generating means,
wherein the converting means generates the image signal with a smaller dispersion than that of a signal of the dispersed object on the basis of the conversion coefficient obtained by the conversion-coefficient calculating mean.

17. The image pickup apparatus according to claim 16, wherein said conversion-coefficient calculating means uses a kernel size of the dispersed object image as a parameter.

18. The image pickup apparatus according to claim 16, further comprising:
storage means,
wherein said conversion-coefficient calculating means stores the obtained conversion coefficient in said storage means, and
wherein the converting means generates the image signal with a smaller dispersion than that of a signal of the dispersed object by converting the image signal on the basis of the conversion coefficient stored in said storage means.

19. The image pickup apparatus according to claim 16, wherein the converting means performs a convolution operation on the basis of the conversion coefficient.

20. The image pickup apparatus according to claim 2, further comprising shooting mode setting means determines a shooting mode of an object, wherein the converting means performs a converting operation corresponding to the shooting mode determined by the shooting mode setting means.

21. image pickup apparatus according to claim 20, wherein the shooting mode is selectable from a normal shooting mode and one of a macro shooting mode and a distant-view shooting mode,
wherein, if the macro shooting mode is selectable, the converting means selectively performs a normal converting operation for the normal shooting mode or a macro converting operation in accordance with the selected shooting mode, the macro converting operation reducing dispersion in a close-up range compared to that in the normal converting operation, and
wherein, if the distant-view shooting mode is selectable, the converting means selectively performs the normal converting operation for the normal shooting mode or a distant-view converting operation in accordance with the selected shooting mode, the distant-view converting operation reducing dispersion in a distant range compared to that in the normal converting operation.

22. The image pickup apparatus according to claim 20, further comprising:
conversion-coefficient storing means for storing different conversion coefficients in accordance with each shooting mode set by the shooting mode setting means; and
conversion-coefficient extracting means for extracting one of the conversion coefficients from the conversion-coefficient storing means in accordance with the shooting mode set by the shooting mode setting means,
wherein the converting means converts the image signal using the conversion coefficient obtained by the conversion-coefficient extracting means.

23. The image pickup apparatus according to claim 22, wherein said conversion-coefficient calculating means uses a kernel size of the dispersed object image as a conversion parameter.

24. The image pickup apparatus according to claim 20, wherein the shooting mode setting means includes
an operation switch for inputting a shooting mode; and
object-distance-information generating means for generating information corresponding to a distance to the object in accordance with input information of the operation switch, and
wherein the converting means performs the converting operation for generating the image signal with the smaller dispersion than that of the signal of the dispersed object image on the basis of the information generated by the object-distance-information generating means.

25. The image processing method comprising:
a storing step of storing the operation coefficient;
a shooting step of picking up an object image, that passes through the optical system, by the image pickup device; and
an operating step of performing a predetermined operation of an image signal from the image pickup device with reference to an operation coefficient;
wherein, in said operation performing step, a filtering process of the optical transfer function (OTF) on the basis of exposure information is performed.
